(19) United States
(12) Patent Application Publication
(10) Pub. No.: US 2003/0054177 A1
(43) Pub. Date: Mar. 20, 2003

(54) Multifunctional energy efficient window coating

(75) Inventor: Ping Jin, Aichi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: National Inst. of Advanced Ind. Science and Tech., Tokyo (JP)

(21) Appl. No.: 10/101,360

(22) Filed: Mar. 20, 2002

(30) Foreign Application Priority Data
Sep. 20, 2001 (JP) 2001-287732

(51) Int. Cl. B32B 17/06

(52) U.S. Cl. 428/432; 428/701; 428/702

(57) ABSTRACT

The present invention provides a multifunctional high-performance automatic chromogenic window coating material in which a vanadium dioxide based thermochromic material is coated by sputtering or the like onto a transparent substrate such as a piece of window glass, and a titanium dioxide based photocatalytic material that also acts as an antireflection film is coated thereon as an outermost layer.

### BACKGROUND OF THE INVENTION

1. Field of the Invention

The present invention relates to a high-performance automatic chromogenic window coating material, and more particularly to a novel high-performance automatic chromogenic window coating material that enables the luminous transmittance of a vanadium dioxide based chromogenic material to be greatly increased and multifunctionality to be realized.

The material of the present invention is useful as a high-performance window coating material that gives a building or a moving body such as an automobile a plurality of functions such as a healthiness/comfort function, an energy saving function and an environment cleansing function, or as a high-performance infrared-chromic material.

2. Description of the Related Art

Vanadium dioxide (VO₂) is thermochromic (i.e. optical properties thereof change reversibly with temperature) due to a semiconductor-to-metal phase transition at a transition temperature of 68° C. By adding a metallic element such as tungsten (W), the transition temperature can be reduced, and hence research has been carried out into the use of such metal-doped vanadium dioxide as a window coating material capable of automatically regulating the transmission of sunlight in accordance with the environmental temperature [1) S. M. Babulanum, T. S. Eriksson, G. A. Niklasson and C. G. Granqvist: Solar Energy Materials, 16 (1987), 347]. Vanadium dioxide based chromogenic window materials (where ‘vanadium dioxide based’ includes the case of vanadium dioxide with a metallic element or the like added thereto) have an very simple structure, and hence have the great advantage of always being transparent during exhibiting thermochromism. However, there have been large drawbacks with conventional vanadium dioxide based chromogenic materials, such as the luminous transmittance in the visible region being very low from the outset, and the materials having nothing more than a single chromogenic function.

There are other window coating materials that have thermochromic properties based on heat, for example an autonomous response type thermochromic glass using a special hydrogel [2) Haruo Watanabe: Taiyo Enerugi (Solar Energy), 1997, Vol. 23, p49]. However, although such materials exhibit excellent thermochromism, there is a drawback that if the glass is exposed to heat, then the glass becomes clouded, and hence the luminous transmittance of the glass is decreased. Applying such a material to the window material of a building or especially a moving body such as an automobile, where a clear field of vision is always required, is problematic.

Moving on, titanium dioxide (TiO₂) based photocatalysts (here ‘titanium dioxide type’ includes the case that other elements are added to the titanium dioxide) have various functions such as a soiling prevention function, an antibacterial function, a deodorant function and an environmental cleansing function [3) Kogyo Zairyo (Industrial Materials), June 1999 edition]. However, these materials do not exhibit a thermochromic light-regulating function.

With the foregoing in view, the present inventors carried out assiduous studies with a goal of developing a high-performance window coating material for which the problems of conventional vanadium dioxide based chromogenic window materials have been resolved. As a result, the present inventors have discovered that this goal can be achieved by coating a vanadium dioxide based thermochromic material onto a transparent substrate and then coating thereon a titanium dioxide thin film that also acts as an antireflection film as an outermost layer, thus arriving at the present invention.

### SUMMARY OF THE INVENTION

The present invention provides a multifunctional high-performance automatic chromogenic window coating material in which a vanadium dioxide based thermochromic material is coated by sputtering or the like onto a transparent substrate such as a piece of window glass, and a titanium dioxide based photocatalytic material that also acts as an antireflection film is coated thereon as an outermost layer. By using the titanium dioxide antireflective film, problems of conventional VO₂ based thermochromic materials are resolved, and the performance thereof is greatly improved. Moreover, it becomes possible to realize a high-performance window coating material that combines functions possessed by the outermost titanium dioxide film, namely photocatalytic functions such as a soiling prevention function, an antibacterial function, a deodorant function, an environmental cleansing function and a water-repellent or hydrophilic function, and a harmful ultraviolet ray cutting function, and the chromogenic function of vanadium dioxide.

It is an object of the present invention to provide a novel high-performance automatic chromogenic window coating material that enables great problems of conventional vanadium dioxide based chromogenic materials, such as the luminous transmittance being low and the materials having nothing more than a single chromogenic function, to be resolved.

Moreover, it is an object of the present invention to develop and provide a novel high-performance window coating material that greatly improves the luminous transmittance of a vanadium dioxide based chromogenic material, and also combines a photocatalytic function and an ultraviolet ray cutting function with a chromogenic function.

Furthermore, it is an object of the present invention to develop and provide a high-performance window coating material that combines an automatic thermochromic function, photocatalytic functions such as a soiling prevention function, an antibacterial function, a deodorant function, an environmental cleansing function and a water-repellent or hydrophilic function, a harmful ultraviolet ray cutting function, and a function of it being possible to always maintain a transparent field of vision.

To solve the above problems, the present invention is constituted from the following technical means.

(1) A high-performance automatic chromogenic window coating material, comprising:

a vanadium dioxide based thermochromic material coated onto a transparent substrate; and

a titanium dioxide based photocatalytic thin film coated thereon as an outermost layer.

(2) The material described in (1) above, wherein said vanadium dioxide based thermochromic material comprises vanadium dioxide, or vanadium dioxide having a metallic element added thereto, or vanadium dioxide having a nonmetal added thereto, and has an automatic thermochoromic function in accordance with changes in environmental temperature.

(3) The material described in (1) above, wherein a titanium dioxide thin film that also acts as an antireflection film is coated on as an outermost layer, which has a property of always maintaining transparency and a high luminous transmittance.

(4) The material described in (1) above, wherein the material has various photocatalytic functions of titanium dioxide and an ultraviolet ray cutting function.

### BRIEF DESCRIPTION OF THE DRAWINGS

FIG. 1 shows the relationship between the film thicknesses in a TiO₂/VO₂ two-layer structure and the luminous transmittance as calculated using an antireflection theory;

FIG. 2 shows the relationship between the film thicknesses in a TiO₂/VO₂/TiO₂/glass three-layer structure and the luminous transmittance as calculated using the antireflection theory;

FIG. 3 shows the change in the spectral transmittance between before and after phase transition for a 50 nm-thick VO₂ thin film on a quartz glass substrate, both for the case that a 50 nm-thick TiO₂ thin film has been vapor-deposited and the case that no such TiO₂ thin film has been vapor-deposited; and

FIG. 4 shows the change in the spectral transmittance between before and after phase transition for a 50 nm-thick VO₂ thin film on a quartz glass substrate, both for the case that the VO₂ thin film is sandwiched between 25 nm-thick TiO₂ thin films and the case that no such TiO₂ thin films are used.

### DESCRIPTION OF THE PREFERRED EMBODIMENTS

The present invention will now be described in further detail.

In the present invention, a transparent substrate such as a piece of window glass is coated with a vanadium dioxide based thermochromic material to a suitable thickness, preferably 20 to 100 nm. To set the transition temperature of the vanadium dioxide based thermochromic material to a prescribed temperature close to room temperature, a metal such as tungsten or molybdenum is added thereto [4) Japanese Patent Application Laid-open No. 7-331430, Method of Manufacturing Thermochromic Material; 5) Japanese Patent Application Laid-open No. 8-3546, Method of Manufacturing Thermochromic Material]. In the present invention, a high-performance automatic chromogenic window coating material is produced in which a titanium dioxide based photocatalytic thin film that also acts as an antireflection film is formed as an outermost layer on the thermochromic thin film that exhibits an excellent chromogenic function at the prescribed temperature close to room temperature.

By adopting the above constitution, the titanium dioxide thin film that forms the outermost layer exhibits various photocatalytic properties and also acts as an antireflection thin film. The optimum thicknesses of the vanadium dioxide and the titanium dioxide are determined through precise optical calculations such that the luminous transmittance of the chromogenic thin film material system is maximized (i.e. the reflectance is minimized).

It goes without saying that, to minimize the reflectance of the above optical system, a multi-layer film structure, a gradient film or the like may be used to prevent reflection as much as possible, so long as the outermost layer is titanium dioxide. For example, a better antireflection effect can be obtained by using a multi-layer structure in which the vanadium dioxide based thin film is sandwiched between titanium dioxide thin films than by using only a single antireflection titanium dioxide thin film as the outermost layer.

It also goes without saying that, in addition to tungsten, Mo, Nb, Ta and the like are also effective as metals added to the vanadium dioxide to reduce the transition temperature. Moreover, it also goes without saying that various methods of improving the photocatalytic properties of titanium dioxide such as plasma irradiation, ion implantation and addition of other elements can be used with the titanium dioxide based thin film(s) in the present invention.

A reactive sputtering method is used to produce the vanadium dioxide thin film having tungsten added thereto. Specifically, a vanadium dioxide thin film having a prescribed amount of tungsten added thereto can be produced by reactive sputtering of an alloy target of vanadium containing a prescribed amount of tungsten, or simultaneous double sputtering of tungsten and vanadium targets.

The titanium dioxide based photocatalytic thin film is formed by a reactive sputtering method using a titanium metal target, or a method in which a titanium dioxide ceramic target is sputtered. To improve the photocatalytic properties, it is effective to add elements such as Fe, Cr, V, Ta, Ce and W to the titanium dioxide, and a prescribed crystalline phase is formed by finely controlling the sputtering conditions.

As described above, sputtering is an example of a preferable method of manufacturing the thin films in the present invention. However, so long as prescribed properties are obtained for the thin film materials, it goes without saying that another method can be used, for example a vacuum deposition method or a sol-gel method. There are thus no particular limitations on the method of producing the thin films.

As described above, the present invention relates to a multifunctional chromogenic thin film material characterized by having a structure in which a vanadium dioxide based termochromic thin film is coated onto a transparent substrate such as a piece of window glass, and a titanium dioxide photocatalytic thin film is suitably coated thereon as an outermost layer. The present invention thus relates to a high-performance window coating material that combines a thermochromic automatic function, photocatalytic functions such as a soiling prevention function, an antibacterial function, a deodorant function, an environmental cleansing function and a water-repellent or hydrophilic function, a harmful ultraviolet ray cutting function due to the fundamental absorption of titanium dioxide and vanadium dioxide, and a function of maintaining transparency and a high luminous transmittance during exhibiting thermochromism.

The most important point in the present invention is that a titanium dioxide based photocatalytic thin film is used as the outermost layer. That is, in the present invention, the use of titanium dioxide enables the luminous transmittance of the material as an antireflection film to be greatly improved, and for a variety of functions to be incorporated into the chromogenic material, for example a soiling prevention function, an antibacterial function, a deodorant function, an environmental cleansing function and a water-repellent or hydrophilic function as a photocatalyst, and an ultraviolet ray cutting function.

With the material system of the present invention, theoretical calculations were carried out using the “Transfer-Matrix Method” to determine the optimum film thicknesses for maximizing the luminous transmittance [6) B. Harbecke: Appl. Phys., B39 (1985), 165]. Specifically, precise calculations were carried out from optical constants for the substances in question such as vanadium dioxide and titanium dioxide [7) M. Tazawa, P. Jin, S. Tanemura: Applied Optics, 37 (1998), 1858; 8) Handbook of Optical Constants of Solids I: ed. Edward D. Palik, Academic Press, (1998) 799], thus obtaining optimum film thicknesses for each of the layer materials such as TiO₂ and VO₂ in a TiO₂/VO₂/glass structure (single-layer antireflection structure) and a TiO₂/VO₂/TiO₂/glass structure (multi-layer antireflection structure).

A reactive sputtering method is used to produce the vanadium dioxide thin film having tungsten added thereto. Specifically, a vanadium dioxide thin film having a prescribed amount of tungsten added thereto can be produced by reactive sputtering of an alloy target of vanadium and tungsten, or simultaneous double sputtering of tungsten and vanadium targets.

The titanium dioxide photocatalytic thin film is formed by a reactive sputtering method using a titanium metal target, or a method in which a titanium dioxide ceramic target is sputtered. A prescribed crystalline phase is formed by finely controlling the sputtering conditions.

As described above, a sputtering method is one of the most suitable methods for producing the thin film materials in the present invention, since a large-area window can be coated uniformly. Other possible methods include a vacuum deposition method and a sol-gel method. The manufacturing cost is lower with these methods, but adhesion and coating uniformity are slightly poorer than with the sputtering method.

Nevertheless, there are no particular limitations on the method of producing the thin films, with it being possible to use an alternative film formation method to sputtering, for example a vacuum deposition method or a sol-gel method, so long as prescribed properties can be obtained for the thin film materials.

### EXAMPLES

The present invention will now be described in detail through examples. It should be noted, however, that the present invention is not limited whatsoever by the following examples.

### Example 1

(1) Apparatus

In the present example, a general-purpose magnetron sputtering apparatus was used for producing the thin films. Up to 3 cathodes can be placed in this apparatus, and electrical power control can be carried out at will for each of the cathodes using a high-frequency power source or a direct current power source. The substrate can be rotated, and the substrate temperature can be set precisely to any temperature from room temperature to 800° C.

(2) Method

A commercially available vanadium target (V, purity 99.9%, diameter 50 mm), a commercially available tungsten target (W, purity 99.99%, diameter 50 mm) and a commercially available titanium dioxide target (TiO₂, purity 99.99%, diameter 50 mm) were installed on the cathodes of the general-purpose magnetron sputtering apparatus described above. The vacuum system was evacuated to below 2.5×10⁻⁶ Pa, argon and oxygen were introduced, and film formation was carried out. The substrate temperature was set in a range from room temperature to 500° C., and various types of substrate were used, for example quartz glass, a silicon single crystal, sapphire and heat-resistant glass.

Firstly, the optimum film thicknesses of the VO₂ and the TiO₂ for the case of forming a two-layer structure on the glass were calculated by an antireflection theory equation using physical properties and optical constants of the substances. As a result, it was found that it is appropriate for the vanadium dioxide film thickness to be 50 nm, and that in this case the visible light antireflection effect is greatest when the titanium dioxide thickness is 50 nm.

Next, the optimum film thicknesses for a multi-layer structure in which the VO₂ on the glass is sandwiched between two layers of TiO₂ (of thicknesses d1 and d2) were calculated using the same method. As a result, it was found that in the case that the VO₂ film thickness is 50 nm, the visible light antireflection effect is greatest when the titanium dioxide thicknesses d1 and d2 are both 25 nm.

A thin film of vanadium dioxide having tungsten added thereto was then produced. Specifically, sputtering was carried out under conditions of a substrate temperature of 500° C., a total pressure of 0.6 Pa, an oxygen amount of 7%, and a high-frequency electrical power of 180W applied to the vanadium target, and a high-frequency electrical power of 10 to 40W applied to the tungsten target, thus forming a 50 nm-thick thin film of vanadium dioxide with tungsten added thereto.

Next, with the vacuum maintained, sputtering was carried out in argon gas with a high-frequency electrical power of 160W applied to the titanium dioxide target, thus forming 50 nm of titanium dioxide on top of the vanadium dioxide, and hence forming a structure having a single antireflection thin film.

Moreover, under the same sputtering conditions, a multi-layer antireflection structure in which a 50 nm-thick VO₂ thin film is sandwiched between two 25 nm-thick titanium dioxide thin films was formed by alternate sputtering.

The compositions and structures of these two structures were evaluated by X-ray diffraction, RBS and the like.

For the sample having a two-layer thin film structure formed on a transparent substrate such as quartz glass or sapphire, the spectral transmittance and the spectral reflectance were measured at 20° C. (when the vanadium dioxide system is a semiconductor phase) and 80° C.(when the vanadium dioxide system is a metallic phase) using a temperature-controllable spectrophotometer. Furthermore, the temperature change of the transmittance at a wavelength of 2000 nm was taken, and the phase transition temperature of the material was determined from the transmittance/temperature curve.

(3) Results

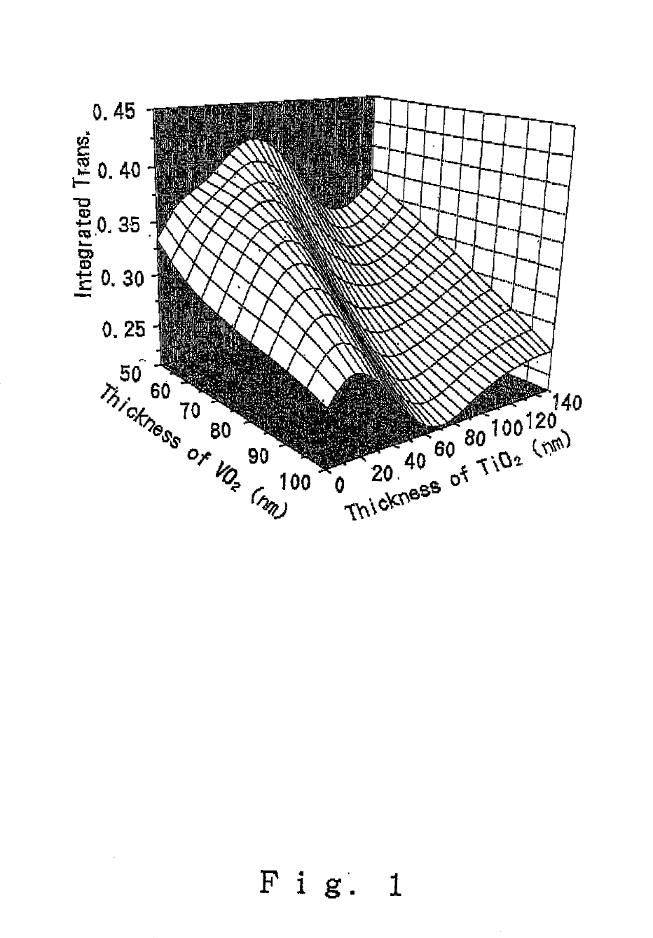

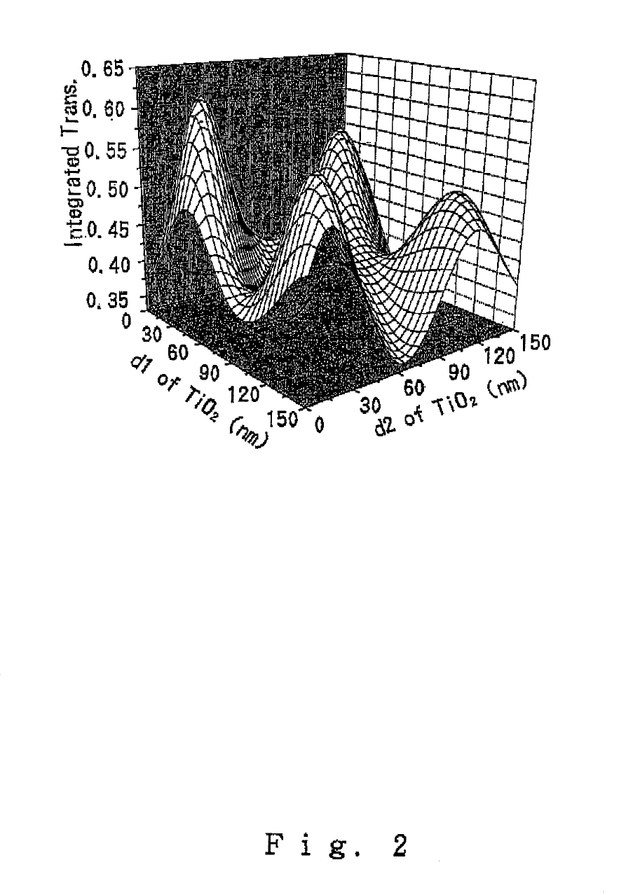

The results of calculating the transmittance of the system through the antireflection theory equation using optical constants for VO₂ and TiO₂ to determine the optimum combination of film thicknesses are shown in FIGS. 1 and 2 for the cases of TiO₂/VO₂/glass single-layer antireflection and TiO₂/VO₂/TiO₂/glass multi-layer antireflection respectively. In the case of single-layer antireflection, it can be seen that, in the case of a 50 nm-thick VO₂ chromogenic thin film on quartz glass, when the TiO₂ thickness is 50 nm the luminous transmittance is greatly increased from 33% to 54%. In the case of multi-layer antireflection, it can be seen that when the 50 nm-thick VO₂ chromogenic thin film is sandwiched between two 25 nm-thick TiO₂ thin films, a luminous transmittance of over 60% is obtained.

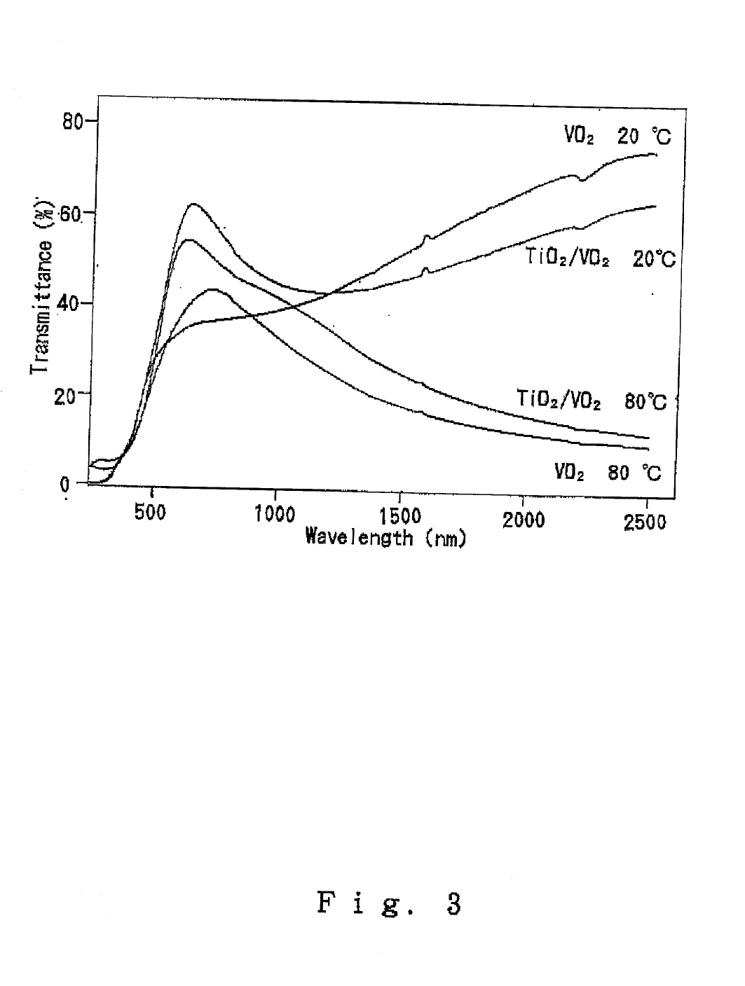

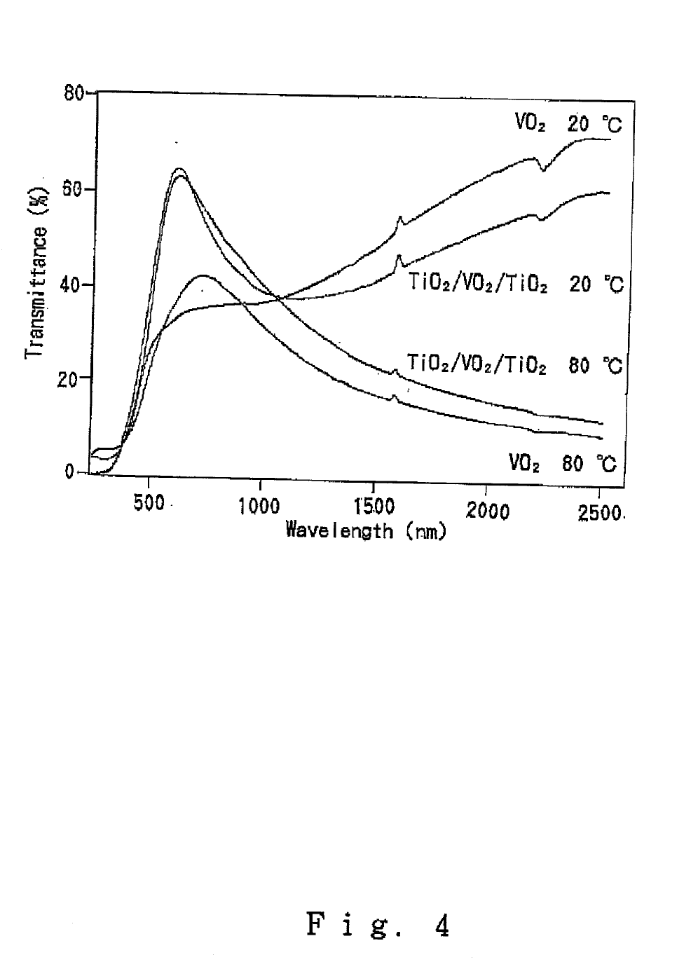

The results of measuring the change in the spectral transmittance between before and after phase transition (before and after thermochromism) for the case that a 50 nm-thick VO₂ layer and a 50 nm-thick TiO₂ layer were formed on a quartz glass transparent substrate by sputtering as described above are shown in FIG. 3. Similarly, the results of measuring the change in the spectral transmittance for the multi-layer structure in which a VO₂ layer (50 nm) on a quartz glass transparent substrate is sandwiched between two TiO₂ layers (d1=d2=25 nm) are shown in FIG. 4. It can be seen that the theoretical calculation results that the luminous transmittance is greatly increased are verified by FIGS. 3 and 4.

### Comparative Example 1

As Comparative Example 1, consider the case that in Example 1 only a vanadium dioxide thin film is used and titanium dioxide thin film(s) is/are not used. It is immediately apparent from the visible light (380 to 760 nm) part of the spectral transmittance curve for the case that only a vanadium dioxide thin film was formed on the quartz glass in FIG. 2 that the luminous transmittance is very low as conventionally.

The present invention was described in detail above through the examples. However, the present invention is not limited to the above example, but rather can be implemented in any form so long as the constitution disclosed in the claims is not deviated from.

As described above in detail, the present invention relates to a high-performance automatic chromogenic window coating material in which a vanadium dioxide based thermochromic material is coated onto a transparent substrate and a titanium dioxide based photocatalytic thin film is coated thereon as an outermost layer. The present invention produces the following notable effects: 1) By using a titanium dioxide antireflective film, problems of conventional VO₂ type thermochromic materials are resolved, and the performance thereof is greatly improved. 2) It becomes possible to realize a high-performance window coating material that combines functions possessed by the outermost titanium dioxide film, namely photocatalytic functions such as a soiling prevention function, an antibacterial function, a deodorant function, an environmental cleansing function and a water-repellent or hydrophilic function, and a harmful ultraviolet ray cutting function, and the chromogenic function of vanadium dioxide. 3) There are great possibilities for industrial application as a multifunctional window coating material that gives a building or a moving body such as an automobile a plurality of functions such as a healthiness/comfort function, an energy saving function and an environment cleansing function, or as a high-performance infrared-chromic element or the like.

What is claimed is:

1. A high-performance automatic chromogenic window coating material, comprising:
a vanadium dioxide based thermochromic material coated onto a transparent substrate; and
a titanium dioxide based photocatalytic thin film coated thereon as an outermost layer.

2. The material according to claim 1, wherein said vanadium dioxide based thermochromic material comprises vanadium dioxide, or vanadium dioxide having a metallic element added thereto, or vanadium dioxide having a nonmetal added thereto, and has an automatic thermochoromic function in accordance with changes in environmental temperature.

3. The material according to claim 1, wherein a titanium dioxide thin film that also acts as an antireflection film is coated on as an outermost layer, which has a property of always maintaining transparency and a high luminous transmittance.

4. The material according to claim 1, wherein the material has various photocatalytic functions of titanium dioxide and an ultraviolet ray cutting function.
